(19) United States
(12) Patent Application Publication
(10) Pub. No.: US 2024/0135255 A1
(43) Pub. Date: Apr. 25, 2024

(54) METHOD AND APPARATUS FOR PROCESSING PREDICTIVE SPATIOTEMPORAL QUERY BASED ON SYNTHETIC DATA

(71) Applicant: ELECTRONICS AND TELECOMMUNICATIONS RESEARCH INSTITUTE, Daejeon (KR)

(72) Inventors: Tae-Whi LEE, Daejeon (KR); Sung-Soo KIM, Daejeon (KR); Choon-Seo PARK, Daejeon (KR); Ki-Hyuk NAM, Yongin-si (KR); Taek-Yong NAM, Daejeon (KR)

(73) Assignee: ELECTRONICS AND TELECOMMUNICATIONS RESEARCH INSTITUTE, Daejeon (KR)

(21) Appl. No.: 18/491,048

(22) Filed: Oct. 19, 2023

(30) Foreign Application Priority Data
Oct. 23, 2022 (KR) 10-2022-0137218
Jul. 13, 2023 (KR) 10-2023-0091861

(51) Int. Cl. G06N 20/00; G06F 16/2458

(52) U.S. Cl. CPC G06N 20/00; G06F 16/2477

(57) ABSTRACT

Disclosed herein is an apparatus for processing a predictive spatiotemporal query based on synthetic data. The apparatus includes a query-processing unit for analyzing a predictive spatiotemporal query of a user and returning a processing result, a machine-learning unit for training a machine-learning model in response to a request from the query-processing unit and generating synthetic spatiotemporal data based on the machine-learning model, and a data storage unit for storing raw spatiotemporal data and the generated synthetic spatiotemporal data, and the raw spatiotemporal data may be stored in the form of a table including an identifier column and a position column.

### CROSS REFERENCE TO RELATED APPLICATIONS

This application claims the benefit of Korean Patent Applications No. 10-2022-0137218, filed Oct. 24, 2022, and No. 10-2023-0091861, filed Jul. 14, 2023, which are hereby incorporated by reference in their entireties into this application.

### BACKGROUND OF THE INVENTION

### 1. Technical Field

The present disclosure relates to technology for processing predictive queries related to spatiotemporal data.

More particularly, the present disclosure relates to technology for processing spatiotemporal queries using synthetic spatiotemporal data generated based on raw spatiotemporal data.

### 2. Description of the Related Art

Spatiotemporal data is data including a timestamp and spatial coordinates, and data types therefor include a moving point, a moving linestring, a moving polygon, and the like. The respective data types may be represented as follows:
moving point: MPOINT ((timestamp₁, x₁, y₁), (timestamp₂, x₂, y₂))

Moving-point-type data may represent that a point was at the spatial coordinates (xₙ, yₙ) at the time indicated by timestampₙ.
moving linestring: MLINESTRING ((timestamp₁, x₁₁, y₁₁, x₁₂, y₁₂, x₁₃, y₁₃, x₁₄, y₁₄), (timestamp₂, x₂₁, y₂₁, x₂₂, y₂₂, x₂₃, y₂₃, x₂₄, y₂₄))

Moving-linestring-type data may represent that a continuous line passing through the points from the spatial coordinates (xₙ₁, yₙ₁) to (xₙ₄, yₙ₄) was at the time indicated by timestampₙ.
moving polygon: MPOLYGON ((timestamp₁, x₁₁, y₁₁, x₁₂, y₁₂, x₁₃, y₁₃, x₁₄, y₁₄, x₁₁, y₁₁), (timestamp₂, x₂₁, y₂₁, x₂₂, y₂₂, x₂₃, y₂₃, x₂₄, y₂₄, x₂₁, y₂₁))

Moving-polygon-type data may represent that a polygon formed by connecting the points from the spatial coordinates (xₙ₁, yₙ₁) to (xₙ₄, yₙ₄) was at the time indicated by timestampₙ.

Spatiotemporal data, such as that described above, may be represented as a relational model, and may be stored and managed in a database or a file by taking the form of a table. Particularly, spatiotemporal data is multidimensional data and is characterized by low density (sparsity) in time and space. Further, it may contain sensitive personal information, which often results in scarcity of data that meets query conditions desired by data analysts. In order to solve this problem, the present disclosure provides a method for generating synthetic data matching analysis conditions through machine learning and providing a query result based thereon.

### DOCUMENTS OF RELATED ART

(Patent Document 1) Korean Patent Application Publication No. 2020-0057823, titled “Apparatus for video data augmentation and method for the same”.

### SUMMARY OF THE INVENTION

An object of the present disclosure is to support a predictive spatiotemporal analytical query even when there is a lack of spatiotemporal data.

Another object of the present disclosure is to generate spatiotemporal data through machine-learning technology, thereby supporting spatiotemporal-query-processing.

In order to accomplish the above objects, an apparatus for processing a predictive spatiotemporal query based on synthetic data according to an embodiment of the present disclosure includes a query-processing unit for analyzing a predictive spatiotemporal query of a user and returning a processing result, a machine-learning unit for training a machine-learning model in response to a request from the query-processing unit and generating synthetic spatiotemporal data based on the machine-learning model, and a data storage unit for storing raw spatiotemporal data and the generated synthetic spatiotemporal data, and the raw spatiotemporal data may be stored in the form of a table including an identifier column and a position column.

Here, the machine-learning unit may select a column of the raw spatiotemporal data to be learned.

Here, the machine-learning unit may train the machine-learning model while changing a condition value for the column to be learned.

Here, the machine-learning unit may store metadata corresponding to training of the machine-learning model, and the metadata may include information about the learned raw spatiotemporal data, information about a condition for the column, and information about the structure of the machine-learning model.

Here, the query-processing unit may analyze the predictive spatiotemporal query of the user, thereby extracting information about target data and columns to be queried. The machine-learning unit may determine whether synthetic spatiotemporal data and a trained machine-learning model are present based on the information about the target data and columns to be queried and return a result value for the predictive spatiotemporal query based on the synthetic spatiotemporal data.

Here, when synthetic data corresponding to the target data and columns to be queried is not present, the machine-learning unit may determine whether a machine-learning model corresponding to the target data and columns to be queried is present.

Here, when synthetic data corresponding to the target data and columns to be queried is not present but a machine-learning model corresponding thereto is present, the machine-learning unit may generate synthetic data corresponding to the target data and columns based on the machine-learning model.

Also, in order to accomplish the above objects, a method for generating synthetic spatiotemporal data according to an embodiment of the present disclosure includes determining a structure of a machine-learning model for generating synthetic spatiotemporal data, training the machine-learning model based on raw spatiotemporal data, and generating synthetic spatiotemporal data based on the machine-learning model, and the raw spatiotemporal data may be stored in the form of a table including an identifier column and a position column.

Here, training the machine-learning model may comprise selecting a column of the raw spatiotemporal data to be learned.

Here, training the machine-learning model may comprise training the machine-learning model while changing a condition value for the column to be learned.

Here, the method may further include storing metadata corresponding to training of the machine-learning model.

Here, the metadata may include information about the learned raw spatiotemporal data, information about a condition for the column, and information about the structure of the machine-learning model.

Also, in order to accomplish the above objects, a method for processing a predictive spatiotemporal query based on synthetic data according to an embodiment of the present disclosure includes analyzing a predictive spatiotemporal query of a user and thereby extracting information about target data and columns to be queried, determining whether synthetic spatiotemporal data and a trained machine-learning model are present based on the information about the target data and columns to be queried, calculating a result value for the predictive spatiotemporal query based on the synthetic spatiotemporal data, and adjusting the result value.

Here, the synthetic spatiotemporal data may be generated based on raw spatiotemporal data stored in the form of a table including an identifier column and a position column.

Here, determining whether the synthetic spatiotemporal data and the trained machine-learning model are present may comprise, when synthetic data corresponding to the target data and columns to be queried is not present, determining whether a machine-learning model corresponding to the target data and columns to be queried is present.

Here, determining whether the synthetic spatiotemporal data and the trained machine-learning model are present may comprise, when synthetic data corresponding to the target data and columns to be queried is not present but a machine-learning model corresponding thereto is present, generating synthetic data corresponding to the target data and columns based on the machine-learning model.

Here, adjusting the result value may comprise adjusting the result value using the difference between the synthetic spatiotemporal data and the raw spatiotemporal data.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating a method for generating synthetic spatiotemporal data according to an embodiment of the present disclosure;

FIG. 2 is a flowchart illustrating a method for processing a predictive spatiotemporal query based on synthetic data according to an embodiment of the present disclosure;

FIG. 3 is a block diagram illustrating a system for processing a predictive spatiotemporal query according to an embodiment of the present disclosure;

FIG. 4 is an example of spatiotemporal data stored in the form of a table;

FIG. 5 is a flowchart illustrating a method for building a machine-learning model for generating synthetic data according to an embodiment of the present disclosure;

FIG. 6 is a flowchart illustrating a method for generating synthetic data according to an embodiment of the present disclosure;

FIG. 7 is a flowchart illustrating a process for processing a spatiotemporal query according to an embodiment of the present disclosure;

FIG. 8 is a block diagram illustrating an apparatus for processing a predictive spatiotemporal query based on synthetic data according to an embodiment of the present disclosure; and

FIG. 9 is a view illustrating the configuration of a computer system according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

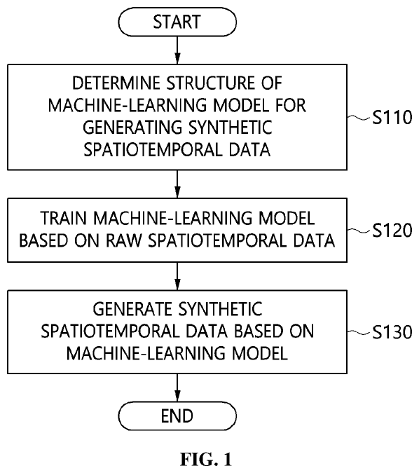

FIG. 1 is a flowchart illustrating a method for generating synthetic spatiotemporal data according to an embodiment of the present disclosure.

The method for generating synthetic spatiotemporal data according to an embodiment of the present disclosure may be performed by an apparatus for generating synthetic spatiotemporal data, such as a computing device.

Referring to FIG. 1, the method for generating synthetic spatiotemporal data according to an embodiment of the present disclosure includes determining the structure of a machine-learning model for generating synthetic spatiotemporal data at step S110, training the machine-learning model based on raw spatiotemporal data at step S120, and generating synthetic spatiotemporal data based on the machine-learning model at step S130.

Here, the raw spatiotemporal data may be stored in the form of a table including an identifier column and a position column.

Here, training the machine-learning model at step S120 may comprise selecting a column of the raw spatiotemporal data to be learned.

Here, training the machine-learning model at step S120 may comprise performing training while changing a condition value for the column to be learned.

Here, although not illustrated in FIG. 1, the method may further include storing metadata corresponding to training of the machine-learning model.

Here, the metadata may include information about the learned raw spatiotemporal data, information about a condition for the column, and information about the structure of the machine-learning model.

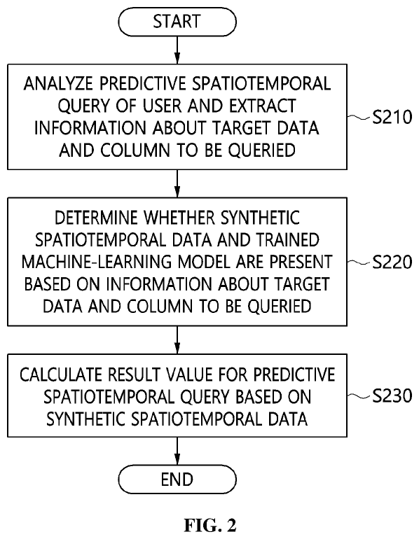

FIG. 2 is a flowchart illustrating a method for processing a predictive spatiotemporal query based on synthetic data according to an embodiment of the present disclosure.

Referring to FIG. 2, the method for processing a predictive spatiotemporal query based on synthetic data according to an embodiment of the present disclosure includes analyzing a predictive spatiotemporal query of a user and thereby extracting information about target data and columns to be queried at step S210, determining whether synthetic spatiotemporal data and a trained machine-learning model are present based on the information about the target data and columns to be queried at step S220, and calculating a result value for the predictive spatiotemporal query based on the synthetic spatiotemporal data at step S230.

Here, although not illustrated in FIG. 2, the method may further include adjusting the result value.

Here, the synthetic spatiotemporal data may be generated based on raw spatiotemporal data stored in the form of a table including an identifier column and a position column.

Here, determining whether synthetic spatiotemporal data and a trained machine-learning model are present at step S220 may comprise, when synthetic data corresponding to the target data and columns to be queried is not present, determining whether a machine-learning model corresponding to the target data and columns to be queried is present.

Here, determining whether synthetic spatiotemporal data and a trained machine-learning model are present at step S220 may comprise, when synthetic data corresponding to the target data and columns to be queried is not present but a machine-learning model corresponding thereto is present, generating synthetic data corresponding to the target data and columns based on the machine-learning model.

Here, adjusting the result value may comprise adjusting the result value using the difference between the synthetic spatiotemporal data and the raw spatiotemporal data.

The present disclosure aims to acquire a prediction analysis result by performing an analytical query by synthesizing spatiotemporal data when there is no spatiotemporal data meeting a condition. The analytical query is a query including an operation for obtaining summarized data, such as an aggregation function (e.g., count, sum, avg, etc.), a user-defined analysis function, or the like, in order to acquire statistical information on target data.

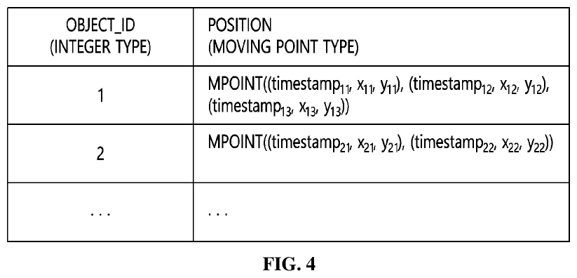

Assume that a table containing spatiotemporal objects is stored under the name of ‘traffic’ as shown in the example of FIG. 4. Here, a spatiotemporal analytical query for counting the number of objects that passed through a rectangular area formed by connecting the points at the coordinates (x₁, y₁), (x₂, y₂), (x₃, y₃), (x₄, y₄), and (x₁, y₁) from 7:00 AM to 9:00 AM on Oct. 1, 2022 may be written as shown in Table 1 below.

```
TABLE 1
SELECT count(*)
  FROM traffic
  WHERE st_passes(position, ‘MPOLYGON( (2022/10/01 07:00:00,((x₁, y₁, x₂, y₂, x₃, y₃, x₄,
y₄, x₁, y₁)) ), (2022/10/01 09:00:00, ((x₁, y₁, x₂, y₂, x₃, y₃, x₄, y₄, x₁, y₁)) )’)=1;
```

The query in Table 1 is a general query for obtaining an accurate result value, but if data related to a specific temporal/spatial range is not sufficient, synthetic data therefor is generated and a predictive spatiotemporal analytical query is performed, whereby a predictive result may be obtained. In order to represent a predictive query, a query may be extended using any of various methods, for example, a method of using a new keyword such as ‘SELECT PREDICTIVE’ or a method of using a hint such as ‘SELECT/*+PREDICTIVE*/’.

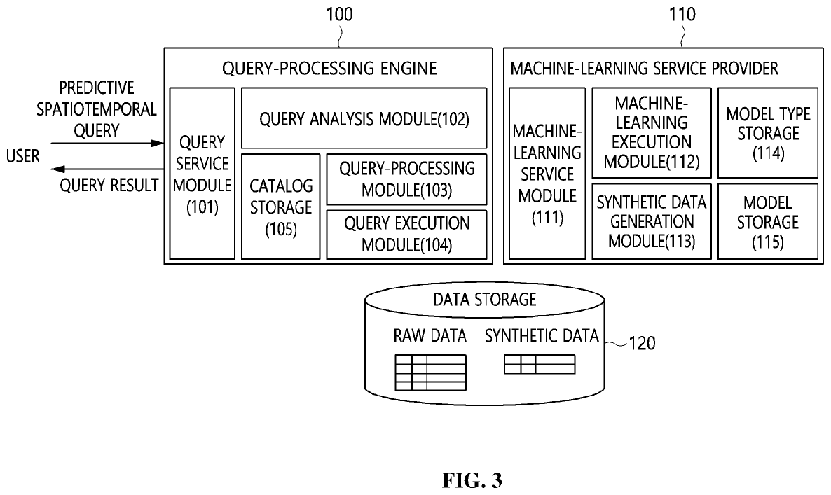

FIG. 3 is a block diagram illustrating a system for processing a predictive spatiotemporal query according to an embodiment of the present disclosure.

Referring to FIG. 3, the system for processing a predictive spatiotemporal analytical query includes a query-processing engine 100, a machine-learning service provider 110, and data storage 120. These blocks may be configured to be located in different machines and to communicate with each other, or may be configured to be located in the same machine.

The query-processing engine 100 includes a query service module 101 for receiving a query from a user and returning a result, a query analysis module 102 for analyzing the syntax and semantics of the query and generating an internal representation corresponding to the query, a query-processing module 103 for making an execution plan depending on the semantics of the query, a query execution module 104 for performing a task by accessing the machine-learning service provider or the data storage depending on the execution plan, and catalog storage 105 for storing information about a machine-learning model and data required for the above-described process.

The machine-learning service provider 110 includes a machine-learning service module 111 for receiving a request for a machine-learning task and providing a result by communicating with the query-processing engine 100, a machine-learning execution module 112 for generating an ML model by training an ML model structure by accessing raw data in the data storage specified in the request for the task, and a synthetic data generation module 113 for generating synthetic data from the trained ML model. Also, there are model type storage 114 for storing ML model structures and model storage 115 for storing a model that is trained for specific data in the machine-learning execution module 112.

The data storage 120 may store raw data and the synthetic data generated by the synthetic data generation module 113.

FIG. 4 is an example of spatiotemporal data stored in the form of a table.

Referring to FIG. 4, an example of simple spatiotemporal data configured with an object_ID column of an integer type, which is a record identifier, and a position column of a moving-point type is illustrated. As shown in the example, spatiotemporal data may be represented as a relational model, and may be stored and managed in the form of a table. Data analysts may analyze data by performing various spatiotemporal queries on such spatiotemporal data by setting time and space information as conditions, such as ‘the number of vehicles (moving-point objects) that passed through a specific area at a specific time’, ‘the average time taken for objects to pass through a specific area’, and the like.

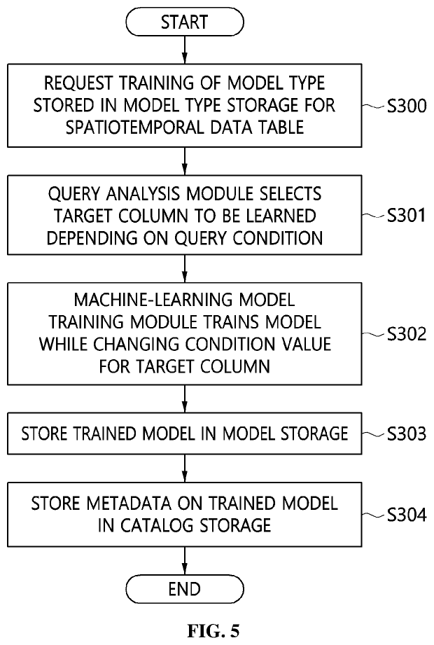

FIG. 5 is a flowchart illustrating a method for building a machine-learning model for generating synthetic data according to an embodiment of the present disclosure.

Referring to FIG. 5, in the method for building a machine-learning model according to an embodiment of the present disclosure, first, a request is made to train a machine-learning model type stored in the model type storage 114 for a spatiotemporal data table desired by a user at step S300. Here, any generative model type that can be used to train a model by inputting query conditions (e.g., a machine-learning model based on a Conditional Generative Adversarial Network (CGAN)) may be used as the model type. The spatiotemporal data query processing engine is required to provide special syntax or APIs such that a user is able to request training of such a model. For example, a method for requesting training of a model may be provided using the following syntax:

TRAIN MODEL m MODELTYPE mtype ON traffic(id, position);

The above syntax may mean ‘train model m, the model type of which is mtype, for id and position columns in traffic table’.

When it receives a request for training, the query service module 101 transfers the same to the query analysis module 102, and the query analysis module 102 selects the target column to be learned depending on the query condition at step S301. Here, the target column to be learned depending on the query condition may be selected by a user or the query-processing engine.

After the query-processing module 103 makes a model training execution plan, the query execution module 104 requests the machine-learning service module 111 of the machine-learning service provider 110 to train the model depending on the model training execution plan.

The machine-learning execution module 112 loads the model type to train from the model type storage 114 in response to the request and performs model training for the spatiotemporal data table to learn while changing a condition value for the target column at step S302.

When the model training process ends, the trained model is stored in the model storage 115 at step S303, and metadata on the trained model, (e.g., the learned table information, the column information learned depending on the condition, the model type information, and the like), which is required for query-processing, is transferred to and stored in the catalog storage 105 at step S304.

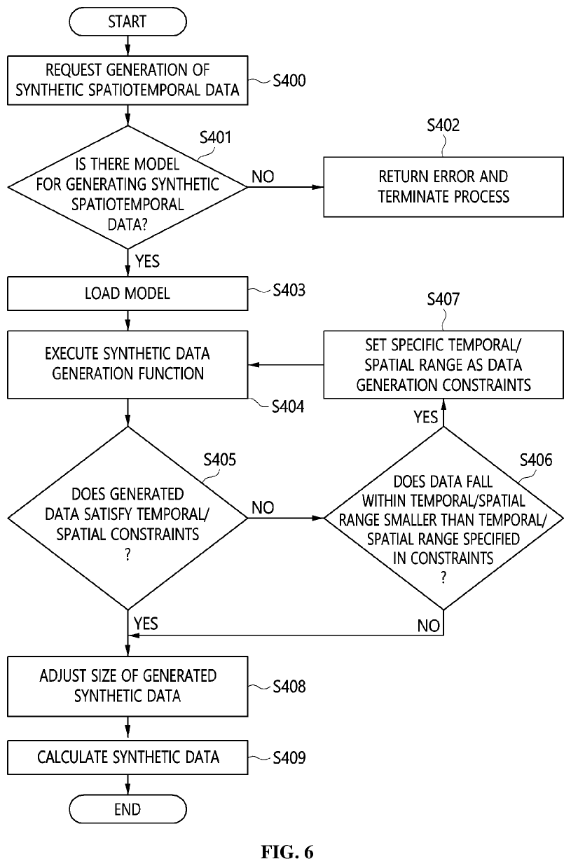

FIG. 6 is a flowchart illustrating a method for generating synthetic data according to an embodiment of the present disclosure.

Referring to FIG. 6, the query service module 101 receives a request to generate synthetic spatiotemporal data at step S400 and transfers the same to the query analysis module 102. When a user makes the request to generate the synthetic data, the user may additionally set constraints for the data to be generated. For example, a constraint that a number of data records equal to or greater than a certain number must be included in a specific time range or in a space zone, a constraint that the number of data records in a specific time range or in a space zone must follow a certain ratio, and the like may be specified. The spatiotemporal data query processing engine may provide special syntax or APIs such that the user is able to make a request to train a model.

The query analysis module 102 checks whether a model available for generation of synthetic data is present by referring to the catalog storage 105 at step S401. When the model is not present, the process is terminated after an error is returned at step S402, whereas when the model is present, a request to generate synthetic data is made to the machine-learning service module 111 of the machine-learning service provider 110. In response to the request, the machine-learning execution module 112 loads the pretrained model and the model type thereof from the model storage 115 and the model type storage 114, respectively, at step S403 and generates synthetic data by executing a function that generates data from the machine-learning model at step S404. When the user's request includes time/space constraints, whether the generated data satisfies the constraints is checked at step S405. When the constraints are not satisfied, whether the generated data falls within a temporal/spatial range smaller than the temporal/spatial range specified in the constraints is checked at step S406, and data records only for the temporal/spatial range within which data is scarce are generated by setting conditions at steps S407 and S404.

After additional data is generated for the temporal/spatial range within which data is scarce, constraints on the proportion of data in each temporal/spatial range are checked for the generated synthetic data, and when the amount of data is excessively large in a certain temporal/spatial range, part of the data in the corresponding range is deleted, whereby the scale of the data is adjusted at step S408. When the entire process is terminated, the generated synthetic data is calculated at step S409. The synthetic data may be generated in advance such that it can be used when a query is processed, or may be generated in the course of processing the query according to need.

When synthetic data is generated in advance, metadata on the synthetic data (e.g., the generated model, column information of a raw data table, and the like) is stored in the catalog storage 105.

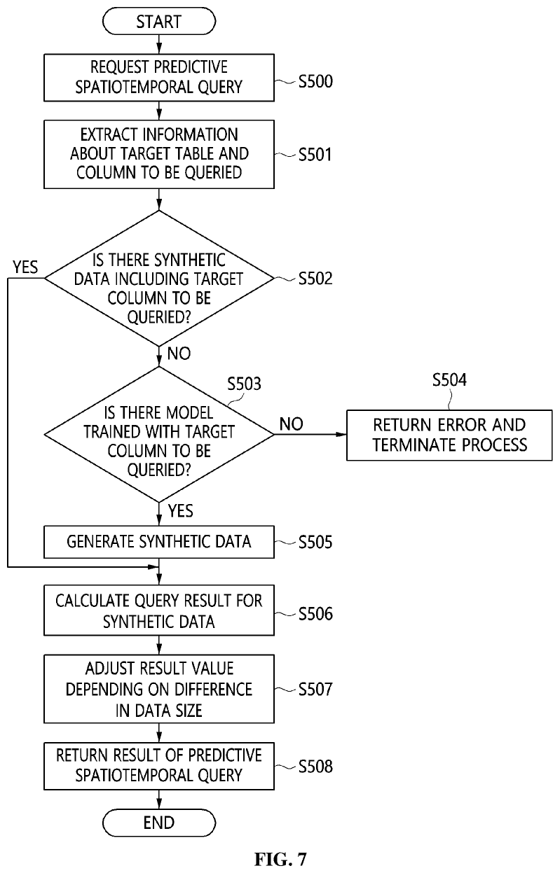

FIG. 7 is a flowchart illustrating a process of processing a spatiotemporal query according to an embodiment of the present disclosure.

Referring to FIG. 7, upon receiving a predictive spatiotemporal query request at step S500, the query service module 101 transfers the same to the query analysis module 102, whereby information about a target table and columns to be queried is extracted at step S501.

Here, whether synthetic data including all of the target columns to be queried has been generated in advance is checked at step S502, and when the generated synthetic data is present, the synthetic data is used. Otherwise, whether a model that is trained with the columns to be queries is present is checked at step S503, and when the trained model is present, synthetic data is generated using the model at step S505 by performing the process illustrated in FIG. 6. When a trained model is not present, an error is returned and the process is terminated at step S504.

Then, using the existing synthetic data or the newly generated synthetic data, a query result may be calculated based on the synthetic data at step S506. When the size of the synthetic data (that is, the number of data records) differs from the size of the raw data table, the extent of the result value pertaining to the synthetic data does not match that pertaining to the raw data, so the different between the predictive result values is adjusted at step S507 and the final predictive query result is returned at step S508.

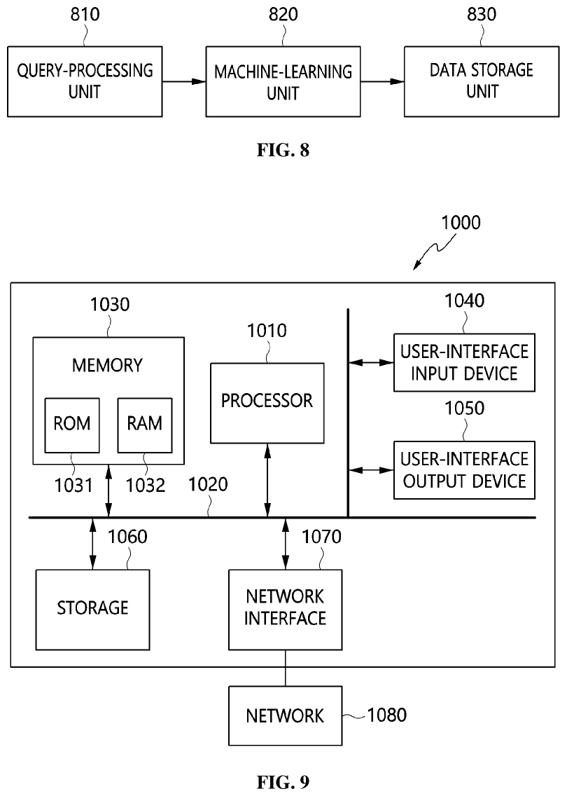

FIG. 8 is a block diagram illustrating an apparatus for processing a predictive spatiotemporal query based on synthetic data according to an embodiment of the present disclosure.

Referring to FIG. 8, the apparatus for processing a predictive spatiotemporal query based on synthetic data according to an embodiment of the present disclosure includes a query-processing unit 810 for analyzing a predictive spatiotemporal query of a user and returning a processing result, a machine-learning unit 820 for training a machine-learning model in response to a request from the query-processing unit and generating synthetic spatiotemporal data based on the machine-learning model, and a data storage unit 830 for storing raw spatiotemporal data and the generated synthetic spatiotemporal data, and the raw spatiotemporal data may be stored in the form of a table including an identifier column and a position column.

Here, the machine-learning unit 820 may select the column to be learned from the raw spatiotemporal data.

Here, the machine-learning unit 820 may train the machine-learning model while changing a condition value for the column to be learned.

Here, the machine-learning unit 820 may store metadata corresponding to training of the machine-learning model, and the metadata may include information about the learned raw spatiotemporal data, information about a condition for the column, and information about the structure of the machine-learning model.

Here, the query-processing unit 810 analyzes the predictive spatiotemporal query of the user, thereby extracting information about the target data and columns to be queried. The machine-learning unit 820 may determine whether synthetic spatiotemporal data and a trained machine-learning model are present based on the information about the target data and columns to be queried and return a result value for the predictive spatiotemporal query based on the synthetic spatiotemporal data.

Here, when synthetic data corresponding to the target data and columns to be queried is not present, the machine-learning unit 820 may determine whether a machine-learning model corresponding to the target data and columns to be queried is present.

Here, when synthetic data corresponding to the target data and columns to be queried is not present but a machine-learning model corresponding thereto is present, the machine-learning unit 820 may generate synthetic data corresponding to the target data and columns based on the machine-learning model.

FIG. 9 is a view illustrating the configuration of a computer system according to an embodiment.

The apparatus for processing a predictive spatiotemporal query based on synthetic data according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the present disclosure, a predictive spatiotemporal analytical query may be supported even when there is a lack of spatiotemporal data.

Also, the present disclosure may generate spatiotemporal data through machine-learning technology, thereby supporting spatiotemporal-query-processing.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. An apparatus for processing a predictive spatiotemporal query based on synthetic data, comprising:
a query-processing unit for analyzing a predictive spatiotemporal query of a user and returning a processing result;
a machine-learning unit for training a machine-learning model in response to a request from the query-processing unit and generating synthetic spatiotemporal data based on the machine-learning model; and
a data storage unit for storing raw spatiotemporal data and the generated synthetic spatiotemporal data,
wherein the raw spatiotemporal data is stored in a form of a table including an identifier column and a position column.

2. The apparatus of claim 1, wherein the machine-learning unit selects a column of the raw spatiotemporal data to be learned.

3. The apparatus of claim 2, wherein the machine-learning unit trains the machine-learning model while changing a condition value for the column to be learned.

4. The apparatus of claim 2, wherein:
the machine-learning unit stores metadata corresponding to training of the machine-learning model, and
the metadata includes information about the learned raw spatiotemporal data, information about a condition for the column, and information about a structure of the machine-learning model.

5. The apparatus of claim 1, wherein:
the query-processing unit analyzes the predictive spatiotemporal query of the user, thereby extracting information about target data and columns to be queried, and
the machine-learning unit determines whether synthetic spatiotemporal data and a trained machine-learning model are present based on the information about the target data and columns to be queried and returns a result value for the predictive spatiotemporal query based on the synthetic spatiotemporal data.

6. The apparatus of claim 5, wherein, when synthetic data corresponding to the target data and columns to be queried is not present, the machine-learning unit determines whether a machine-learning model corresponding to the target data and columns to be queried is present.

7. The apparatus of claim 5, wherein, when synthetic data corresponding to the target data and columns to be queried is not present but a machine-learning model corresponding thereto is present, the machine-learning unit generates synthetic data corresponding to the target data and columns based on the machine-learning model.

8. A method for generating synthetic spatiotemporal data, comprising:
determining a structure of a machine-learning model for generating synthetic spatiotemporal data;
training the machine-learning model based on raw spatiotemporal data; and
generating synthetic spatiotemporal data based on the machine-learning model,
wherein the raw spatiotemporal data is stored in a form of a table including an identifier column and a position column.

9. The method of claim 8, wherein training the machine-learning model comprises selecting a column of the raw spatiotemporal data to be learned.

10. The method of claim 9, wherein training the machine-learning model comprises training the machine-learning model while changing a condition value for the column to be learned.

11. The method of claim 9, further comprising:
storing metadata corresponding to training of the machine-learning model.

12. The method of claim 11, wherein the metadata includes information about the learned raw spatiotemporal data, information about a condition for the column, and information about the structure of the machine-learning model.

13. A method for processing a predictive spatiotemporal query based on synthetic data, comprising:
analyzing a predictive spatiotemporal query of a user, thereby extracting information about target data and columns to be queried;
determining whether synthetic spatiotemporal data and a trained machine-learning model are present based on the information about the target data and columns to be queried;
calculating a result value for the predictive spatiotemporal query based on the synthetic spatiotemporal data; and
adjusting the result value.

14. The method of claim 13, wherein the synthetic spatiotemporal data is generated based on raw spatiotemporal data stored in a form of a table including an identifier column and a position column.

15. The method of claim 14, wherein determining whether the synthetic spatiotemporal data and the trained machine-learning model are present comprises, when synthetic data corresponding to the target data and columns to be queried is not present, determining whether a machine-learning model corresponding to the target data and columns to be queried is present.

16. The method of claim 15, wherein determining whether the synthetic spatiotemporal data and the trained machine-learning model are present comprises, when the synthetic data corresponding to the target data and columns to be queried is not present but the machine-learning model corresponding thereto is present, generating synthetic data corresponding to the target data and columns based on the machine-learning model.

17. The method of claim 14, wherein adjusting the result value comprises adjusting the result value using a difference between the synthetic spatiotemporal data and the raw spatiotemporal data.
